(19) United States
(12) Patent Application Publication
(10) Pub. No.: US 2014/0251545 A1
(43) Pub. Date: Sep. 11, 2014

(54) Process and Method for Recycling Carpet or Other Fibrous Plastic Materials

(71) Applicants: Blake Burich, Dublin, OH (US); David Murdock, Dublin, OH (US)

(72) Inventors: Blake Burich, Dublin, OH (US); David Murdock, Dublin, OH (US)

(21) Appl. No.: 14/202,824

(22) Filed: Mar. 10, 2014

Related U.S. Application Data
(60) Provisional application No. 61/774,997, filed on Mar. 8, 2013.

(51) Int. Cl. B29B 17/02

(52) U.S. Cl. CPC B29B 17/02; B29B 2017/0217; B29K 2913/00; B29L 2009/00
USPC 156/701; 264/138

(57) ABSTRACT

A process and method for recycling carpet is disclosed. The process and method involves the liberation and separation of desirable carpet face fibers from the carpet backing materials. The present invention eliminates face fiber shearing. In the present process, the secondary layer of the carpet backing is removed either manually or mechanically. Then, the bottom of the primary backing layer of the carpet with the bottom of the face fiber “U's” exposed, is mechanically grip-abraded by a rubber material. The grip-abrasion of the rubber or rubber-like material across the bottom of the primary carpet backing layer loosens the glue and grips and pulls the face fiber from the primary backing without destructing primary or secondary backing. The liberation and separation of face fibers from the backing materials using this method produces the highest yield of usable materials compared to any other method. It not only separates the entire face fiber for recycling, but it also allows the backing material to be recycled since it is not contaminated with face fibers.

### CLAIM OF PRIORITY

This application claims priority to U.S. Provisional Application Ser. No. 61/774,997 which was filed on Mar. 8, 2013 and which is incorporated by reference.

### BACKGROUND AND SUMMARY OF THE INVENTION

The present invention relates to a process for recycling carpet. As current statistics reveal, carpet accounts for over 60% of all flooring sales in the developed world. Among the various kinds of carpeting the “tufted” carpet or wall-to-wall carpet product that most homebuilders use represents the majority of all the carpet types that are sold.

Tufted Carpet is traditionally made of face fibers (Nylon, Polypropylene, and Polyester) that are stitched into a backing material. See FIG. 1. The face fibers are cut to create a walking surface. This “cut pile” carpeting creates a face fiber that is a “U” shape with the bottom of the “U” in the backing material. The carpet's backing material consists of two polypropylene mesh layers that sandwich a SB latex bonding agent. The primary layer is the topmost layer and has the face fiber stitched through it. The secondary layer is the bottom-most layer, which encloses the SB latex bonding agent material. The SB latex bonding agent, contains a calcium carbonate filler and binds the two layers and the bottom “U” of the face fibers together.

Tufted carpet is very difficult to recycle because about 90% of the face fibers used to manufacture carpeting are made out of Nylon or Polyester. Nylon and Polyester have a much higher melting point then the Polypropylene backing material. So, it is not possible to combine the two dissimilar polymers and melt them into a usable pellet for plastic manufacturing. If you heat the combined materials enough to melt the nylon or polyester, then you will burn the polypropylene material. So the majority of post-consumer carpeting is land filled. The weight and size of discarded carpeting has created a very large disposal problem for landfills.

Carpet America Recovery Effort (CARE) is a non-profit organization that has made admirable strides in educating businesses and individuals about how to recycle carpet. CARE claims that over five billion pounds of post consumer carpeting is land filled every year. In an attempt to address the problems associated with the disposal of used carpet, CARE has come up with a few recycling programs. These programs have created a small carpet recycling industry. Some carpet recycling companies are collectors, some are processors and other companies use the post consumer carpet to burn as waste to energy.

Most carpet recycling processing companies shear the face fibers from the backing material and throw the backing material or “carcass” away. This shearing method produces a very low yield of recyclable material from incoming raw material and has high disposal costs. The shearing machinery is also very expensive to maintain. Many carpet recyclers have gone out of business due to the low yield of salable material, high maintenance costs and the disposal costs of unusable materials going to landfill. The carpet recycling industry is in need of lower cost solutions to remain viable.

The present invention creates a much more versatile, lower cost alternative to the traditional shearing of face fiber. In addition, the typical “waste” polypropylene backing material is also diverted from landfill and is able to be recycled.

In addition to the novel features and advantages mentioned above, other features and advantages of the present invention will be readily apparent from the following descriptions and exemplary embodiments.

### BRIEF DESCRIPTION OF THE DRAWINGS

FIG. 1 is an illustration of cut pile carpet construction.

FIG. 2 is a depiction of removing the secondary backing layer.

FIG. 3 is a depiction of applying a spinning rubber wheel against the bottom of the primary carpet backing layer to loosen the SB latex bonding agent and pull the face fiber from the primary backing layer.

FIG. 4 is a depiction of applying a rubber blade that moves back and forth against the bottom of the primary carpet backing layer to loosen the SB latex bonding agent and pull the face fiber from the primary backing layer.

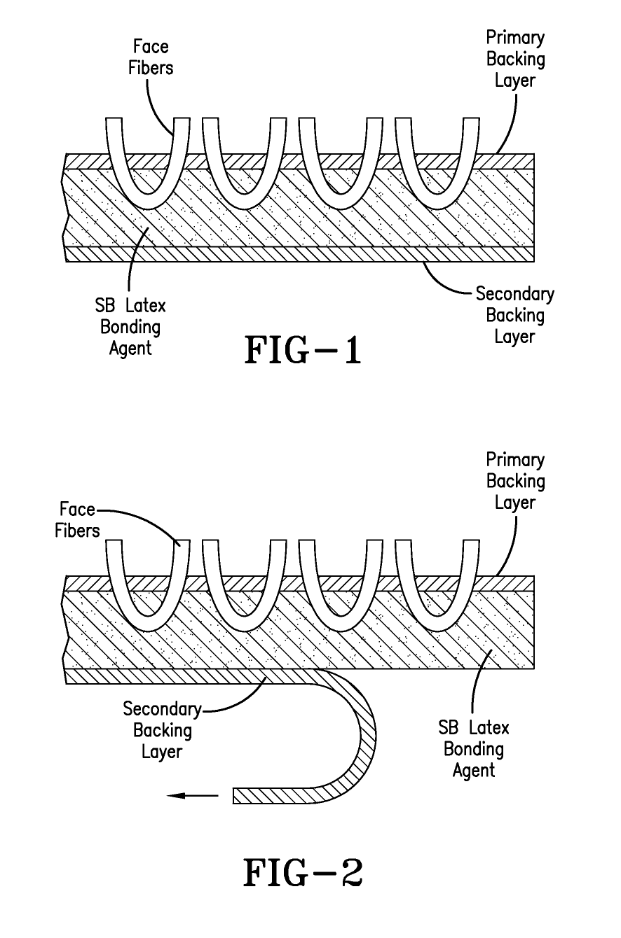

### DETAILED DESCRIPTION OF EXEMPLARY EMBODIMENT(S)

Waste carpet is diverted from landfill and separated by face fiber polymer type. The separated piles or carpet can either be baled or cut and stacked onto pallets and is now prepared for processing. The secondary backing layer of the carpet is removed through manual or automated mechanical means. See FIG. 2.

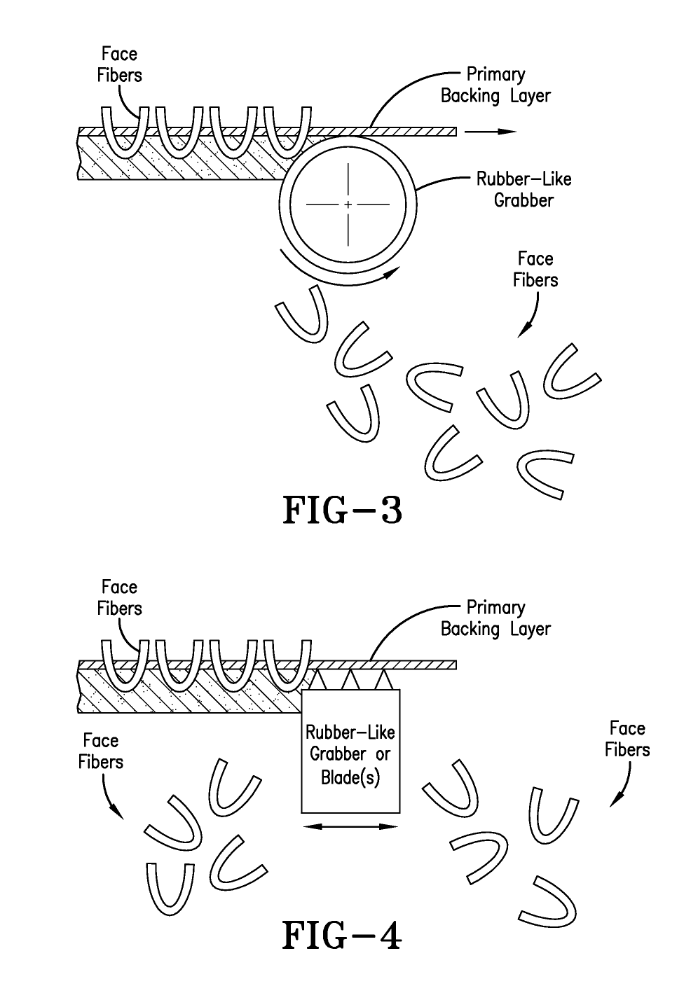

The primary backing layer is then applied against a rubber or rubber-like material that grabs the bottom of the primary backing layer. The grabbing force of the rubber or rubber-like material loosens the SB latex bonding agent and grabs the face fibers pulling them through the primary backing layer without destructing the primary or secondary. This liberates and separates the face fiber material from the backing materials. Numerous configurations may be used to produce the same effect and embodiment of the invention. The rubber material may be a wheel that spins in either rotational direction to loosen the SB latex bonding agent and pull the face fibers from the primary backing layer. See FIG. 3.

The primary backing layer could also be pulled across the rubber wheel or other rubber shaped surface in a vertical or horizontal position.

Configurations of blade-like shapes of rubber or rubber-like material would grab the primary backing layer by moving forward and backward to loosen the SB latex bonding agent and remove the face fibers. Configuration of material would be chosen through testing of effectiveness or as one who is skilled in the art might determine. See FIG. 4.

After the face fibers are removed from the primary backing layer, they can be baled and sold for recycling. The face fibers may also still have some residual SB latex bonding agent or calcium carbonate material attached to them. It may be desirable to further purify the face fibers to be able to sell them at a higher value. This can be accomplished by many methods. One method is to hammer mill the face fiber material and liberate the SB latex bonding agent material from it. The fiber can then be screened to separate it from the SB latex bonding agent materials. A washing, drying and screening process can also be used to separate the face fibers from the SB latex bonding agent materials. This material can be baled or extruded into a pellet.

The polypropylene primary and secondary backing layers can be baled and sold for recycling. The polypropylene primary and secondary backing layers may also still have some residual SB latex bonding agent or calcium carbonate material attached to them. It may be desirable to further purify the face fibers to be able to sell them at a higher value. This can be accomplished by many methods. One method is to size reduce the polypropylene sheets through a shredder. The shredded polypropylene can then be hammer milled to liberate the SB latex bonding agent material from it. The fiber can then be screened to separate it from the SB latex bonding agent materials. A washing, drying and screening process can also be used to separate the polypropylene from the SB latex bonding agent materials. This material can be baled or extruded into a pellet.

The polypropylene backing material may also be shredded for use as filler or insulation in any number of various products.

The polypropylene backing material sheets may also be kept whole and used for other products such as erosion control material, garden fencing, tree wrap, or multiple other products.

The polypropylene backing material sheets may also be kept whole and used for use in a number of other applications because it is easily shaped and molded if it is heated to approximately 350-400 degrees Fahrenheit. This material may be heated and cooled in a mold to make an interior automotive panel, an interior building product such as a dry wall corner bead, a concrete insulating moisture pad to build upon or many other products.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. For example, the process may be shifted to have the carpet motionless and the aforementioned tooling with action. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A process for recycling carpeting, said process comprising: Manual and/or automated mechanical removal of the carpets secondary backing layer. After the secondary backing layer has been removed, the remaining primary backing layer now has the bottom “U” of the face fibers and the SB latex bonding agent exposed. A rubber material (or other materials that display good traction and various degrees of hardness) is used to abrade the bottom of the primary backing layer, which loosens the SB latex bonding agent and “grips” and pulls the face fiber from the primary backing layer without destructing the primary or secondary backing. The face fiber is now liberated and separated from the two primary and secondary carpet layers, but it still may have some minor amount of SB bonding agent attached to it. If needed, the face fiber can be hammer milled, screened and/or washed to further remove any remaining SB latex or calcium carbonate materials and prepare it for recycling. If needed, the polypropylene backing layers can both be size reduced, hammer milled, screened and/or washed to further remove any residual SB latex or calcium carbonate materials and prepare it for recycling. The polypropylene backing layers could also be kept whole as a sheet to be used in other products such as erosion control material, garden fencing or tree wrap.

2. The process of claim 1, further comprising the step of removing the secondary backing layer through a manual or automated mechanical means.

3. The process of claim 1, using a rubber or rubber-like material to abrade the bottom of the primary backing layer to loosen the SB latex bonding agent and pull the face fibers through the primary backing.

4. The process of claim 1, using a rubber or rubber-like material with a smooth surface or tread patterned surface to abrade the bottom of the primary backing layer to loosen the SB latex bonding agent and pull the face fibers through the primary backing.

5. The process of claim 1, further comprising the step of liberating and separating the face fibers from the carpet backing layer.

6. The process of claim 1, further comprising the step of hammer milling, screening and/or washing the face fibers to further remove any remaining SB latex or calcium carbonate materials and to prepare the face fibers for recycling.

7. The process of claim 1, further comprising the step of extruding the face fibers into a pellet.

8. The process of claim 1, further comprising the step of size reducing, hammer milling, screening and/or washing the polypropylene backing layers to further remove any residual SB latex or calcium carbonate materials and prepare the polypropylene backing layers for recycling.

9. The process of claim 1, further comprising the step of extruding the polypropylene backing material into a pellet.

10. The process of claim 1, further comprising the step of retaining the cleaned polypropylene carpet backing layer sheets for other products such as erosion control material, garden fencing, tree wrap, or any application one skilled in the art may decide.

11. The process of claim 1, further comprising the step that this material may be ground and used as filler, insulation or any application one skilled in the art may decide.

12. The process of claim 1, further comprising the step of retaining the cleaned polypropylene carpet backing layer sheets, once the face fibers have been removed, for use in a number of applications because it is easily shaped and molded if it is heated to approximately 350-400 degrees Fahrenheit. This material may be heated and cooled in a mold to make an interior automotive panel, an interior building product such as a dry wall corner bead, a concrete insulating moisture pad to build upon or any application that one skilled in the art may decide.
